(19) United States
(12) Patent Application Publication
(10) Pub. No.: US 2026/0186394 A1
(43) Pub. Date: Jul. 2, 2026

(54) PROJECTOR

(71) Applicant: Coretronic Corporation, Hsin-Chu (TW)

(72) Inventors: Yu-Peng CHEN, Hsin-Chu (TW); Chun-Hsin LU, Hsin-Chu (TW); Wen-Chieh CHUNG, Hsin-Chu (TW)

(21) Appl. No.: 19/434,007

(22) Filed: Dec. 29, 2025

(30) Foreign Application Priority Data
Dec. 30, 2024 (CN) 2024119748658

(51) Int. Cl. G03B 21/14; G02B 3/00; G02B 7/198; G03B 21/00; G03B 21/20

(52) U.S. Cl. CPC G03B 21/147; G02B 3/0056; G02B 7/198; G03B 21/008; G03B 21/2066; G03B 21/208

(57) ABSTRACT

A projector includes an illumination module, a reflective light valve and a projection lens. The reflective light valve is arranged on the transmission path of the illumination light beam provided by the illumination module and is configured to convert the illumination light beam into an image light beam. The projection lens is arranged on the transmission path of the image light beam and is configured to project the image light beam outside the projector to form an image. By adjusting the shapes and the angles of the first micro lenses of a first micro lens array in the illumination module, the problem of the current projector that the reflected light beam would still enter the aperture when some of the reflective mirrors are in the flat-state and there are diffraction patterns entering the aperture when some of the reflective mirrors are in the off-state may be improved.

### CROSS REFERENCE TO RELATED APPLICATION

This application claims the priority benefit of Chinese Patent Application Serial Number 2024119748658, filed on Dec. 30, 2024, the full disclosure of which is incorporated herein by reference.

### BACKGROUND

### Technical Field

The present disclosure is related to the technical field of optics and is particularly related to a projector.

### Related Art

In current projectors, a reflective light valve is a common technology for light modulations. The reflective light valve includes a plurality of reflective mirrors which are arranged as an array, and each reflective mirror has three deflection states, i.e., an on-state, a flat-state and an off-state. In an ideal condition, when the reflective mirrors are in the on-state, one part of an incident illumination light beam is reflected by the reflective mirrors to enter the aperture of a projection lens and serves as one part of an image light beam; when the reflective mirrors are in the flat-state or the off-state, the incident illumination light beam after being reflected does not enter the aperture of the projection lens. However, based on the technical limitations of the current reflective light valve, a reflected light beam would still enter the aperture when some of the reflective mirrors are in the flat-state, and there are still some light beams entering the aperture and diffraction patterns would be generated around the aperture when some of the reflective mirrors are in the off-state, thereby decreasing the contrast ratio of a projection image.

A current method of increasing the contrast ratio of the projection image is to obstruct the reflected light beam at a position where the reflected light beam enters the aperture or a position where the diffraction patterns overlap the aperture when the reflective mirrors are in the flat-state by arranging a shutter at the aperture or changing the shape of the aperture in order to improve the contrast ratio of the projection image. Nevertheless, the brightness of the projection image would be sacrificed due to the partially obstructed aperture. Thus, a manufacturer can only select one of enhancing the brightness of the projection image and enhancing the contrast ratio of the projection image to implement, and it is impossible to enhance the contrast ratio of the projection image efficiently while enhancing brightness.

Hence, the prior art indeed has a necessity to further provide a more improved solution.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

In light of the deficiencies of the current technologies, the object of the present disclosure provides a projector which changes the light beam by changing the micro lens array of the projector without obstructing the aperture of the projection lens. As a result, in the projector of the present disclosure, the contrast ratio may be efficiently enhanced when the high brightness is kept.

In order to achieve one, one part or all of the objectives, the projector in one embodiment of the present disclosure includes an illumination module, a reflective light valve and a projection lens. The illumination module is configured to provide an illumination light beam and includes a light source device and a first micro lens array. The light source device generates a light beam, the first micro lens array includes a plurality of first micro lenses which are arranged tightly, each of the first micro lenses forms a first orthogonal projection on a first reference plane, and the first orthogonal projection has a first shape. The first micro lens array is disposed on the transmission path of the light beam, and the light beam passes through the first micro lens array and leaves the illumination module as the illumination light beam. The reflective light valve is disposed on the transmission path of the illumination light beam, is configured to convert the illumination light beam into an image light beam and includes a plurality of reflective micromirrors which are arranged as an array. The reflective micromirrors form an effective image region with a long side and a short side, and each reflective micromirror is adapted to be operated in one of a first state with a first deflection angle and a second state without any deflection angle. The illumination light beam is incident on the reflective micromirrors when each of the reflective micromirrors is in the first state, and the reflective micromirrors reflect the illumination light beam to form a first light beam as the image light beam. The illumination light beam is incident on the reflective micromirrors when each of the reflective micromirrors is in the second state, and the reflective micromirrors reflect the illumination light beam to form a second light beam. The projection lens is disposed on the transmission path of the image light beam and is configured to project the image light beam outside the projector to form an image. The projection lens includes an aperture disposed on a second reference plane perpendicular to the optical axis of the projection lens. The first light beam forms a first illumination region on the second reference plane, while the second light beam forms a second illumination region on the second reference plane. The shape of the first illumination region and the shape of the second illumination region correspond to the first shape, and the first illumination region overlaps the aperture. The orthogonal projection of the first illumination region on the reflective light valve is provided with a projection short axis and a projection long axis perpendicular to the projection short axis, and the included angle between the projection long axis and the long side of the effective image region is greater than 0 degrees and less than or equal to 90 degrees.

Other objectives, features and advantages of the present invention will be further understood from the further technological features disclosed by the embodiments of the present invention wherein there are shown and described preferred embodiments of this invention, simply by way of illustration of modes best suited to carry out the invention.

By the foregoing structure, the problem of the current projector that the reflected light beam would still enter the aperture when some of the reflective mirrors are in the flat-state and there are still some light beams entering the aperture and diffraction patterns would be generated around the aperture when some of the reflective mirrors are in the off-state may be improved without arranging the shutter at the aperture of the projection lens, and thus the contrast ratio is enhanced under the condition that the brightness is not excessively sacrificed.

### BRIEF DESCRIPTION OF THE DRAWINGS

FIG. 1 is the schematic diagram of the optical structure of a projector according to one embodiment of the present disclosure.

FIG. 2 is the schematic diagram of the optical structure of a projector according to another embodiment of the present disclosure.

FIG. 3 is the plan schematic diagram of a first type of a first micro lens array according to the present disclosure viewed along a first incident direction.

FIG. 4 is the enlarged schematic diagram of the orthogonal projection on a first reference plane of one first micro lens in the RA region shown in FIG. 3.

FIG. 5 is the plan schematic diagram of a second type of a first micro lens array according to the present disclosure viewed along the first incident direction.

FIG. 6 is the enlarged schematic diagram of the orthogonal projection on the first reference plane of one first micro lens in the RB region shown in FIG. 5.

FIG. 7 is the plan schematic diagram of a third type of a first micro lens array according to the present disclosure viewed along the first incident direction.

FIG. 8 is the enlarged schematic diagram of the orthogonal projection on the first reference plane of one first micro lens in the RC region shown in FIG. 7.

FIG. 9 is the plan schematic diagram of a fourth type of a first micro lens array according to the present disclosure viewed along the first incident direction.

FIG. 10 is the enlarged schematic diagram of the orthogonal projection on the first reference plane of one first micro lens in the RD region shown in FIG. 9.

FIG. 11 is the plan schematic diagram of a fifth type of a first micro lens array according to the present disclosure viewed along the first incident direction.

FIG. 12 is the enlarged schematic diagram of the orthogonal projection on the first reference plane of one first micro lens in the RE region shown in FIG. 11.

FIG. 13 is the plan schematic diagram of a first type of a reflective light valve according to the present disclosure.

FIG. 14 is the plan schematic diagram of one reflective micromirror of the first type of the reflective light valve.

FIG. 15 is the schematic diagram of the different illumination regions on a second reference plane formed by an illumination light beam after being incident on the first type of the reflective light valve with the reflective micromirrors on different states.

FIG. 16 is the schematic diagram of the orthogonal projection on the reflective light valve of a first illumination region.

FIG. 17 is the plan schematic diagram of a second type of a reflective light valve according to the present disclosure.

FIG. 18 is the plan schematic diagram of one reflective micromirror of the second type of the reflective light valve.

FIG. 19 is the schematic diagram of the different illumination regions on the second reference plane formed by the illumination light beam after being incident on the second type of the reflective light valve with the reflective micromirrors on different states.

FIG. 20 is the schematic diagram of the orthogonal projection on the reflective light valve of a first illumination region.

FIG. 21 is the plan schematic diagram of a third type of a reflective light valve according to the present disclosure.

FIG. 22 is the plan schematic diagram of one reflective micromirror of the third type of the reflective light valve.

FIG. 23 is the schematic diagram of the different illumination regions on the second reference plane formed by the illumination light beam after being incident on the third type of the reflective light valve with the reflective micromirrors on different states.

FIG. 24 is the schematic diagram of the orthogonal projection on the reflective light valve of a first illumination region.

FIG. 25 is the simulation diagram of the first illumination region formed according to the first micro lens array shown in FIG. 3.

FIG. 26 is the simulation diagram of the first illumination region formed according to the first micro lens array shown in FIG. 5.

FIG. 27 is the comparison diagram of simulation results under the application architecture of the first type of the reflective light valve.

### DETAILED DESCRIPTION OF THE EMBODIMENTS

The technical solutions in the embodiments of the present disclosure will be described clearly and completely in conjunction with the accompanying drawings in the embodiments of the present disclosure as follows. Apparently, the described embodiments are merely one part of the embodiments of the present disclosure and not all embodiments of the present disclosure. Based on the embodiments of the present disclosure, all embodiments obtained by a person skilled in the art without any inventive steps shall fall within the scope of protection of the present disclosure.

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

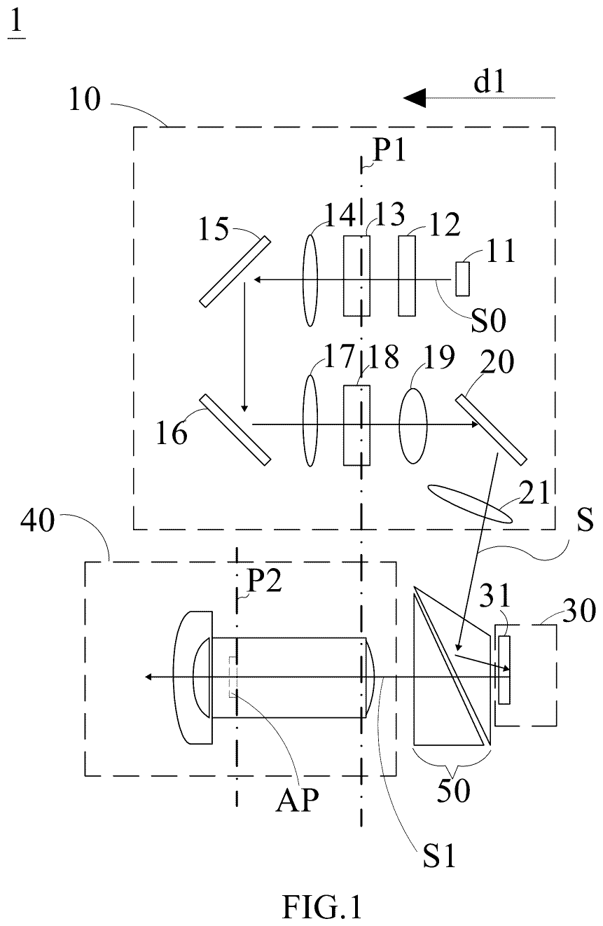

FIG. 1 is the schematic diagram of the optical structure of a projector according to one embodiment of the present disclosure. As shown in FIG. 1, a projector 1 includes an illumination module 10, a light modulation module 30 and a projection lens 40. The illumination module 10 is configured to provide an illumination light beam S, and the light modulation module 30 is disposed on the transmission path of the illumination light beam S. Moreover, the light modulation module 30 is configured to convert the illumination light beam S into an image light beam S1. The projection lens 40 is disposed on the transmission path of the image light beam S1. The projection lens 40 is configured to project the image light beam S1 outside the projector 1 to form an image. For example, the projection lens 40 includes the combinations of one or more optical lenses with diopters, and the combinations of one or more optical lenses with the diopters are the various combinations of non-planar lenses such as bi-concave lenses, bi-convex lenses, concavo-convex lenses, convexo-concave lenses, plano-convex lenses and plano-concave lenses. In one embodiment, the projection lens 40 may further include a planar optical lens to project the image light beam S1 from the light modulation module 30 onto a projection target. The present disclosure does not limit the form and the type of the projection lens 40. In the present embodiment, the light modulation module 30 includes a reflective light valve 31. The reflective light valve 31, for example, is a digital micromirror device (DMD). The illumination module 10 includes at least one light source device 11, and the at least one light source device 11 includes at least one light-emitting component. The at least one light-emitting component may be constituted by encapsulating at least one light-emitting diode (LED) or at least one laser diode (LD).

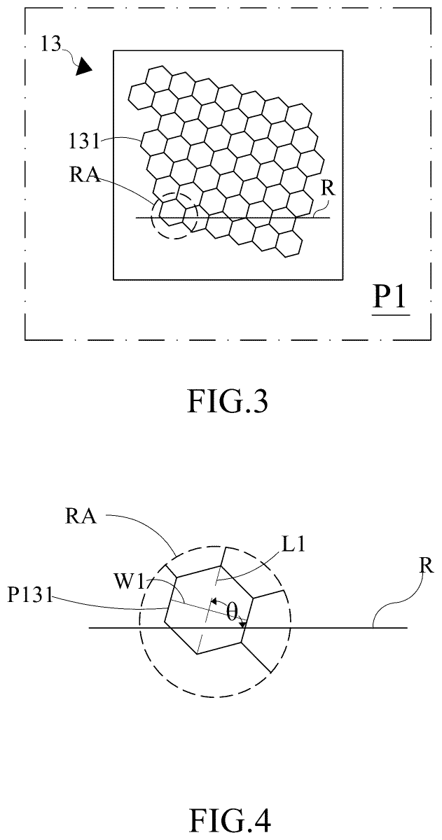

Please refer to FIG. 3. In one embodiment, the illumination module 10 includes at least one light source device 11 and a first micro lens array 13. The light source device 11 is configured to generate a light beam S0; the first micro lens array 13 includes a plurality of first micro lenses 131 which are arranged tightly, each first micro lens 131 forms a first orthogonal projection P131 on a first reference plane P1, and the first orthogonal projection P131 has a first shape. The first micro lens array 13 is disposed on the transmission path of the light beam S0, and the light beam S0 leaves the illumination module 10 after passing through the first micro lens array 13 as the illumination light beam S.

In one embodiment, the illumination module 10 further includes a second micro lens array 18 disposed on the transmission path of the light beam S0, and the light beam S0 leaves the illumination module 10 after sequentially passing through the first micro lens array 13 and the second micro lens array 18 as the illumination light beam S.

In one embodiment, the illumination module 10 further includes a diffuser 12, a first light source collimating lens 14, a first reflector 15, a second reflector 16, a first light source condenser lens 17, a second light source collimating lens 19, a third reflector 20 and a second light source condenser lens 21. Moreover, each of the diffuser 12, the first micro lens array 13, the first light source collimating lens 14, the first reflector 15, the second reflector 16, the first light source condenser lens 17, the second micro lens array 18, the second light source collimating lens 19, the third reflector 20 and the second light source condenser lens 21 is sequentially disposed on the transmission path of the light beam S0 generated by the light source device 11 so that the passed light beam S0 forms the illumination light beam S to leave the illumination module 10. In the present embodiment, the light beam S0 leaves the illumination module 10 from the second light source condenser lens 21 and enters the light modulation module 30 as the illumination light beam S.

In one embodiment, the projector 1 further includes a prism 50, and the reflective light valve 31 and the prism 50 are disposed on the transmission path of the illumination light beam S. The prism 50 is configured to adjust the angle at which the illumination light beam S is incident on the reflective light valve 31. The illumination light beam S is incident on the reflective light valve 31 through the prism 50, and at least one part of the illumination light beam S is converted and is reflected by the reflective light valve 31 to form the image light beam S1 entering the projection lens 40.

Furthermore, referring to FIG. 1 again, the first micro lens array 13 is disposed along the first reference plane P1, the light source device 11 and the diffuser 12 are disposed on the front side of the first reference plane P1, and the first light source collimating lens 14 is disposed on the rear side of the first reference plane P1. Moreover, the front side and the rear side of the first reference plane P1 are opposite sides of the first reference plane P1. The projection lens 40 includes an aperture AP. The aperture AP may be an independent light blocking component, and may also be the inner diameter structure of a lens tube or a minimum aperture formed by a lens. The aperture AP of the projection lens 40 is located on a second reference plane P2 perpendicular to the optical axis of the projection lens 40. In some embodiments, the first reference plane P1 and the second reference plane P2 are parallel to each other, and may be perpendicular to the bottom surface of the case of the projector 1. However, the present disclosure is not limited thereto. In the present embodiment, the light beam S0 generated by the light source device 11 is incident on the first micro lens array 13 along a first incident direction d1 perpendicular to the first reference plane P1.

In the foregoing embodiments, after the light source device 11 generates the light beam S0, the light beam S0 is diffused by the diffuser 12, and the diffused light beam S0 then passes through the first micro lens array 13. The first micro lens array 13 performs light beam shaping on the diffused light beam S0. After being collimated by the first light source collimating lens 14, the shaped light beam S0 sequentially travels to the first reflector 15 and the second reflector 16 to change the travel direction of the light beam S0. After the light beam S0 is subsequently reflected by the first reflector 15 and the second reflector 16, the travel direction of the light beam S0, for example, is parallel to and opposite to the first incident direction d1. Afterwards, the light beam S0 after being reflected by the second reflector 16 enters the first light source condenser lens 17, and the light beam S0 converged by the first light source condenser lens 17 travels to the second micro lens array 18 to perform the light beam shaping. The light beam S0 shaped by the second micro lens array 18 enters the second light source collimating lens 19 and is transmitted to the second light source condenser lens 21 by the reflection of the third reflector 20 after being collimated by the second light source collimating lens 19.

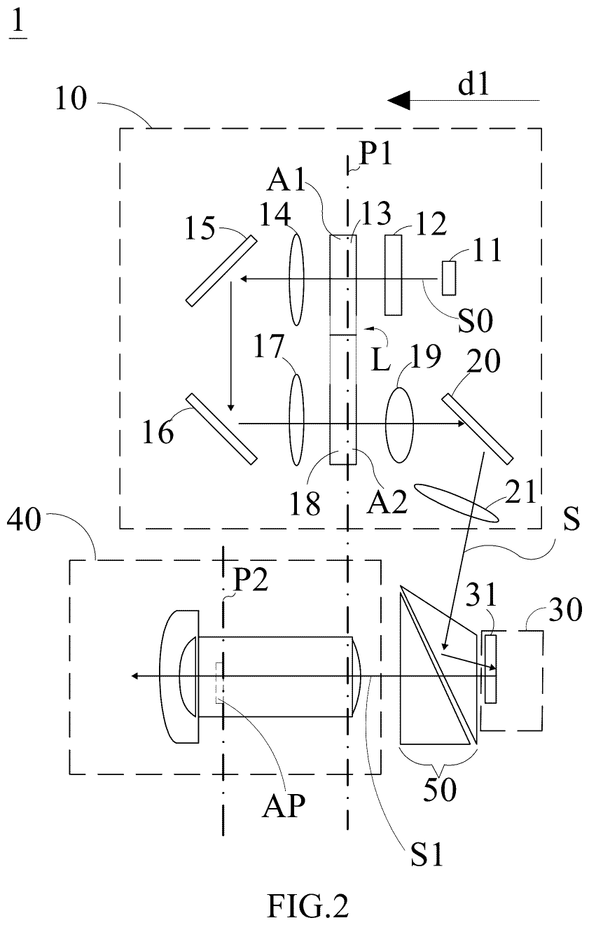

FIG. 2 is the schematic diagram of the optical structure of a projector according to another embodiment of the present disclosure. As shown in FIG. 2, in the present embodiment, each component is mostly the same as the corresponding component in the foregoing embodiment, and the difference between the optical structure of the projector of FIG. 2 and the optical structure of the projector of FIG. 1 is: the first micro lens array 13 and the second micro lens array 18 may be integrated into one micro lens array component L. The micro lens array component L is disposed along the first reference plane P1. Moreover, the micro lens array component L is provided with a first region A1 and a second region A2, and the first region A1 and the second region A2 are disposed in parallel to each other along the first reference plane P1. The first micro lens array 13 is disposed on the first region A1, and the second micro lens array 18 is disposed on the second region A2. For example, the first micro lens array 13 and the second micro lens array 18 are an integrally formed single component (the micro lens array component L).

Furthermore, in the first micro lens array 13 of the present disclosure, the arrangement angle and the shape of each first micro lens 131 may be adjusted, and the variations of the arrangement angle and the shape of each first micro lens 131 in the first micro lens array 13 of the present disclosure would be further explained as follows.

FIG. 3 is the plan schematic diagram of the first type of the first micro lens array 13 according to the present disclosure viewed along the first incident direction d1. FIG. 4 is the enlarged schematic diagram of the first orthogonal projection P131 on the first reference plane P1 of one first micro lens 131 in the RA region shown in FIG. 3. As shown in FIG. 3 and FIG. 4, the first shape of the first orthogonal projection P131 of each first micro lens 131 on the first reference plane P1 has a first axis L1 and a second axis W1, the length of the first axis L1 is greater than the length of the second axis W1, and the first axis L1 and the second axis W1 are the symmetric axes of the first shape.

In the present embodiment, the first shape is a hexagon, the first axis L1 is the connecting line between two opposite corners of the hexagon, and the second axis W1 is the connecting line between two midpoints of two opposite sides of the hexagon.

Specifically, there is the intersection angle θ between the first axis L1 of the first shape and a reference line R located on the first reference plane P1, and the intersection angle θ is greater than 0 degrees and less than or equal to 90 degrees. In different embodiments, the intersection angle θ may be 15 degrees, 30 degrees, 45 degrees, 40 degrees, 75 degrees or 90 degrees.

In addition, the length of the first axis L1 and the length of the second axis W1 meet formula (1) as follows:

$$\frac{D 2}{D 1} = \frac{\sqrt{3}}{2} * A \qquad formula ( 1 )$$

wherein D1 is the length of the first axis L1, D2 is the length of the second axis W1, A is an aspect ratio and is a real number, and 0.3≤A≤1. It can be understood that the first orthogonal projection of the first shape is a regular hexagon when A=1.

The first orthogonal projection P131 shown in FIG. 4 is that A=1 and the intersection angle θ is about 60 degrees.

In order to better understand of the variations of the arrangement angle and the shape of each first micro lens 131 of the present disclosure, the following would elaborate the variations of the various shapes and the various arrangement angles of each first micro lens 131 of the present disclosure.

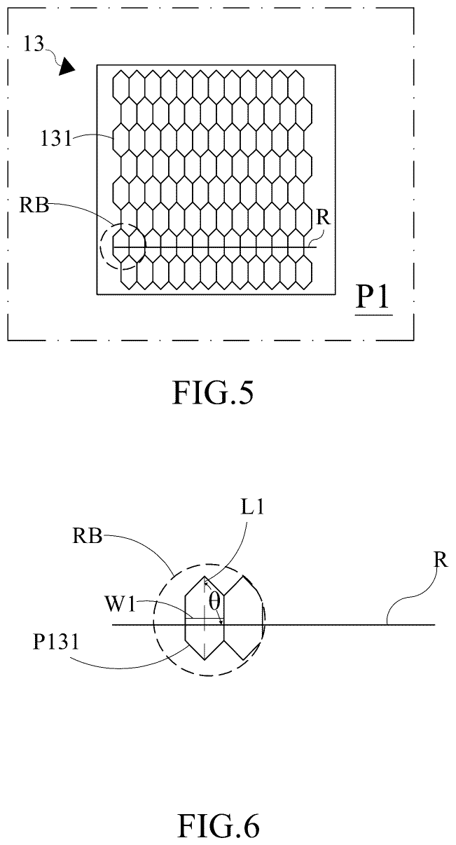

FIG. 5 is the plan schematic diagram of the second type of the first micro lens array 13 according to the present disclosure viewed along the first incident direction d1. FIG. 6 is the enlarged schematic diagram of the first orthogonal projection P131 on the first reference plane P1 of one first micro lens 131 in the RB region shown in FIG. 5. As shown in FIG. 5 and FIG. 6, the first shape of the first orthogonal projection P131 of each first micro lens 131 on the first reference plane P1 is that A=0.5 and the intersection angle θ is about 90 degrees.

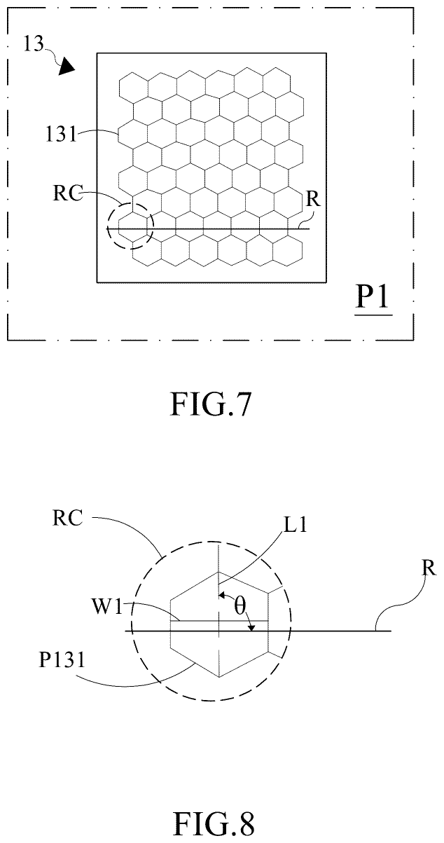

FIG. 7 is the plan schematic diagram of the third type of the first micro lens array 13 according to the present disclosure viewed along the first incident direction d1. FIG. 8 is the enlarged schematic diagram of the first orthogonal projection P131 on the first reference plane P1 of one first micro lens 131 in the RC region shown in FIG. 7. As shown in FIG. 7 and FIG. 8, the first shape of the first orthogonal projection P131 of each first micro lens 131 on the first reference plane P1 is that A=1 and the intersection angle θ is about 90 degrees.

In addition, in the other embodiments, the shape of each first micro lens 131 of the first micro lens array 13 may also be any other shape such as a rectangle which is also a polygon or may be an ellipse.

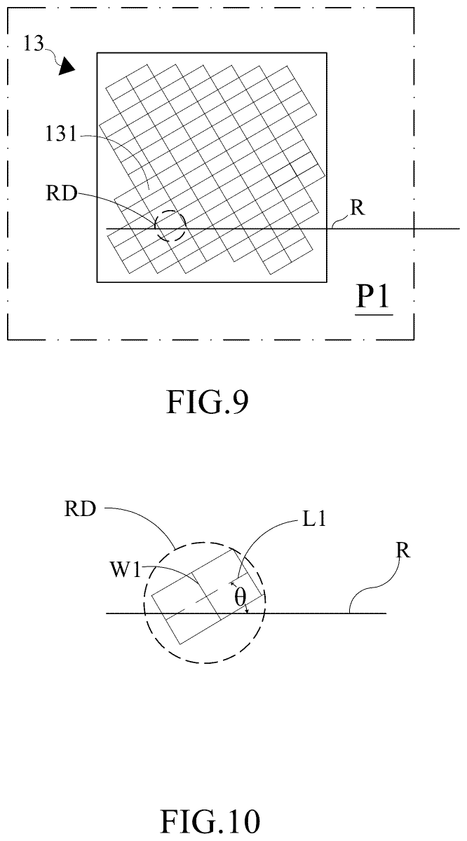

FIG. 9 is the plan schematic diagram of the fourth type of the first micro lens array 13 according to the present disclosure viewed along the first incident direction d1. FIG. 10 is the enlarged schematic diagram of the first orthogonal projection P131 on the first reference plane P1 of one first micro lens 131 in the RD region shown in FIG. 9. The first shape of the first orthogonal projection P131 of each first micro lens 131 on the first reference plane P1 in the present embodiment is the rectangle; hence, the first axis L1 is the connecting line between two midpoints of two opposite sides which are far apart from each other, and the second axis W1 is the connecting line between two midpoints of two opposite sides which are close to each other.

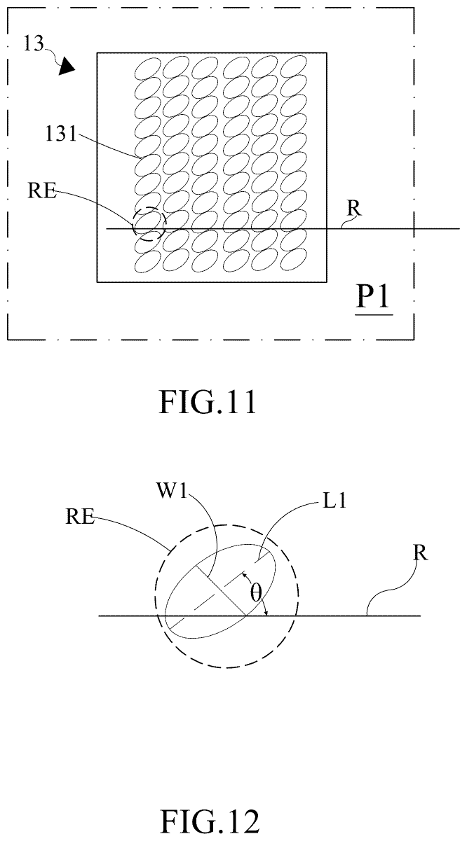

FIG. 11 is the plan schematic diagram of the fifth type of the first micro lens array 13 according to the present disclosure viewed along the first incident direction d1. FIG. 12 is the enlarged schematic diagram of the first orthogonal projection P131 on the first reference plane P1 of one first micro lens 131 in the RE region shown in FIG. 11. The first shape of the first orthogonal projection P131 of each first micro lens 131 on the first reference plane P1 in the present embodiment is the ellipse; hence, the first axis L1 is the major axis of the ellipse, and the second axis W1 is the minor axis of the ellipse

Similar to the first micro lens arrays 13 illustrated in FIG. 3 to FIG. 8, there is the intersection angle θ between the first axis L1 of the first shape of the first orthogonal projection P131 of the first micro lens 131 on the first reference plane P1 and the reference line R located on the first reference plane P1, and the intersection angle θ is greater than 0 degrees and less than or equal to 90 degrees. In different embodiments, the intersection angle θ may be 15 degrees, 30 degrees, 45 degrees, 40 degrees, 75 degrees or 90 degrees for example. In addition, the length of the first axis L1 and the length of the second axis W1 equally meet formula (1).

It can be understood that the light beam S0, serving as the illumination light beam S to illuminate the reflective light valve 31, after sequentially passing through the first micro lens array 13 and the second micro lens array 18, and undergoes the modulation of the reflective light valve 31, the light beam shaping of the light beam S0 by the first micro lens array 13 and the second micro lens array 18 contributes to the correspondence between the angle space of the modulated light beam S0 and the shape of the first micro lens 131 of the first micro lens array 13 (the first shape of the first orthogonal projection P131 of the first micro lens 131 on the first reference plane P1). Furthermore, the contour of the illumination region which the modulated light beam S0 enters the projection lens 40 to project and to form on the second reference plane P2 corresponds to the shape of the first micro lens 131. The said correspondence, for example, is the similarity of geometric shapes.

In other words, when the shape of the first micro lens 131 would differ according to the adjustment of the aspect ratio and/or the adjustment of the intersection angle θ, the contour of the illumination region which is formed on the second reference plane P2 by the image light beam S1 would correspondingly change.

The following would elaborate the application architecture of three different types of the reflective light valves 31 of the present disclosure separately.

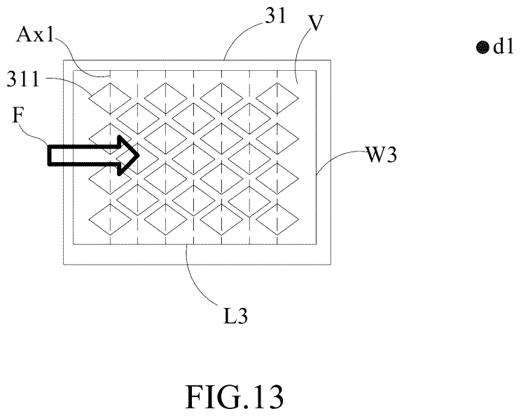

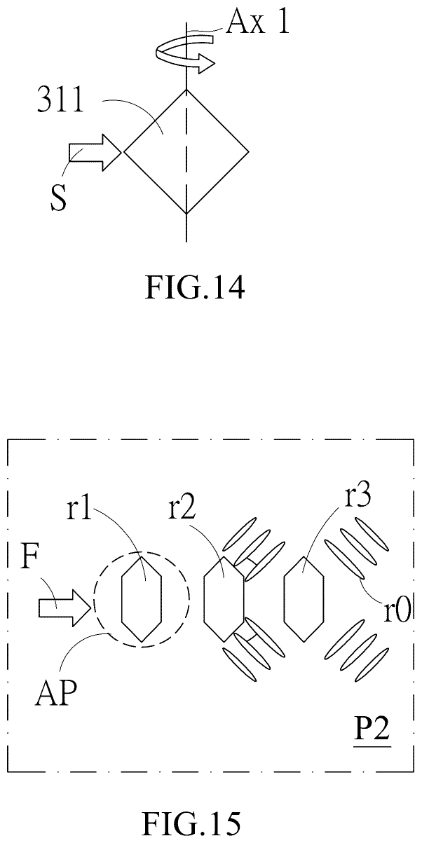

FIG. 13 is the plan schematic diagram of the first type of the reflective light valve 31 according to the present disclosure. FIG. 14 is the plan schematic diagram of one reflective micromirror 311 of the first type of the reflective light valve 31. As shown in FIG. 13, the reflective light valve 30 includes a plurality of reflective micromirrors 311 which are arranged as the array, and the reflective micromirrors 311 form an effective image region V with a long side L3 and a short side W3. Each reflective micromirror 311 has a rotation axis Ax1, and each reflective micromirror 311 rotates by regarding the rotation axis Ax1 as a reference axis so that each reflective micromirror 311 is adapted to be operated in a first state with a first deflection angle, a second state without any deflection angle and a third state with a second deflection angle. In one embodiment, the first state of each reflective micromirror 311, for example, is the on-state, the second state of each reflective micromirror 311, for example, is the flat-state, and the third state of each reflective micromirror 311, for example, is the off-state. In the first type of the reflective light valve 31, the rotation axis Ax1 is parallel to the short side W3 of the effective image region of the reflective light valve 31, and the illumination light beam S is incident in the direction of the short side W3.

FIG. 15 is the schematic diagram of the different illumination regions on the second reference plane P2 formed by the illumination light beam S after being incident on the first type of the reflective light valve 31 with the reflective micromirrors 311 on the different states.

In conjunction with FIG. 13 to FIG. 15, in the first type of the reflective light valve 31, the illumination light beam S is incident on the reflective micromirrors 311 when each reflective micromirror 311 is in the first state, the reflective micromirrors 311 reflect the illumination light beam S to form a first light beam serving as the image light beam S1 to enter the projection lens 40, and the first light beam forms a first illumination region r1 on the second reference plane P2. When each reflective micromirror 311 is in the second state, the illumination light beam S is incident on the reflective micromirrors 311, the reflective micromirrors 311 reflect the illumination light beam S to form a second light beam, and the second light beam forms a second illumination region r2 on the second reference plane P2. When each reflective micromirror 311 is in the third state, the illumination light beam S is incident on the reflective micromirrors 311, the reflective micromirrors 311 reflect the illumination light beam S to form a third light beam, and the third light beam forms a third illumination region r3 on the second reference plane P2. In addition, the third light beam would also form diffraction patterns r0 on the second reference plane P2 with the third illumination region r3 as a center.

As explained above, the contours of the illumination regions which the first light beam, the second light beam and the third light beam reflected by the reflective light valve 31 form on the second reference plane P2 where the aperture AP of the projection lens 40 is located correspond to the shape of the first micro lens 131 of the first micro lens array 13, and as a result, the shape of the first illumination region r1, the shape of the second illumination region r2 and the shape of the third illumination region r3 correspond to the first shape of the first orthogonal projection P131 of the first micro lens 131 on the first reference plane P1. For example, the shape of the first illumination region r1, the shape of the second illumination region r2 and the shape of the third illumination region r3 shown in FIG. 15 correspond to the first shape of the first orthogonal projection P131 on the first reference plane P1 of the first micro lens 131 of the second type of the first micro lens array 13 shown in FIG. 5 and FIG. 6.

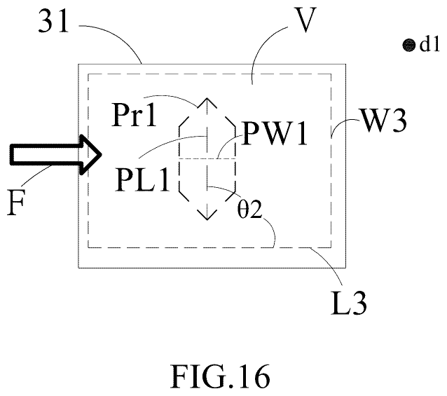

Thereafter, the relationship between the first illumination region r1, the first type of the reflective light valve 31 and the illumination light beam S would be elaborated. FIG. 16 is the schematic diagram of the orthogonal projection Pr1 which the first illumination region r1 forms on the reflective light valve 31.

Please further refer to FIG. 5, FIG. 6 and FIG. 16. The orthogonal projection Pr1 which the first illumination region r1 forms on the reflective light valve 31 is provided with a projection long axis PL1 and a projection short axis PW1 which are perpendicular to each other. The projection long axis PL1 and the projection short axis PW1 respectively correspond to the first axis L1 and the second axis W1 of the first orthogonal projection P131 of the first micro lens 311 on the first reference plane P1. When the illumination light beam S is incident on the reflective light valve 31, the orthogonal projection Pr1 of the optical axis of the illumination light beam S (a major ray) on the reflective light valve 31 is a first projection optical axis F, and the first projection optical axis F is parallel to the projection short axis PW1 of the orthogonal projection Pr1 of the first illumination region r1 on the reflective light valve 31. Thus, under the condition that the ratio of the projection long axis PL1 and the projection short axis PW1 is fixed, the parallelism of the first projection optical axis F and the projection short axis PW1 can ensure that the distance between the second illumination region r2 and the first illumination region r1 is the greatest, thereby preventing the second light beam generated when the reflective micromirror 311 is in the second state from entering the aperture AP.

In addition, because the projection long axis PL1 and the projection short axis PW1 respectively correspond to the first axis L1 and the second axis W1, the length of the projection long axis PL1 and the length of the projection short axis PW1 meet formula (2) similar to formula (1) as follows:

$$\frac{D 4}{D 3} = \frac{\sqrt{3}}{2} * A \qquad formula ( 2 )$$

wherein D3 is the length of the projection long axis PL1, D4 is the length of the projection short axis PW1, A is still the aspect ratio.

Additionally, there is the included angle θ 2 between the projection long axis PL1 and the long side L3 of the effective image region V of the reflective light valve 31, and the included angle θ 2 is greater than 0 degrees and less than or equal to 90 degrees.

In the application architecture of the first type of the reflective light valve 31, because the first projection optical axis F is parallel to the long side L3 of the effective image region V, and the first projection optical axis F should be parallel to the projection short axis PW1, the included angle θ 2 between the projection long axis PL1 and the long side L3 of the effective image region Vis approximately equal to 90 degrees.

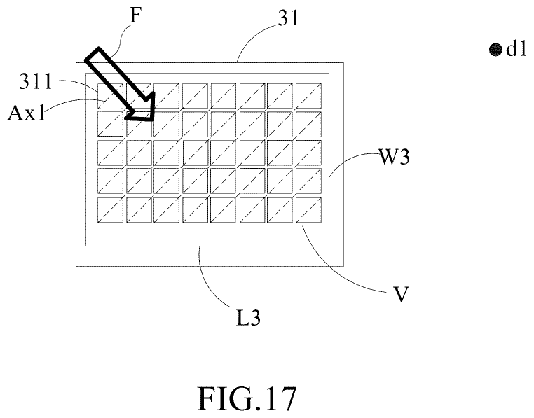

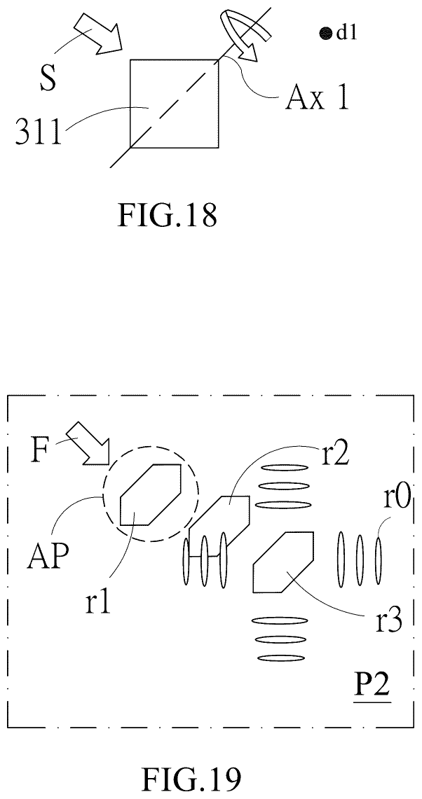

FIG. 17 is the plan schematic diagram of the second type of the reflective light valve 31 according to the present disclosure. FIG. 18 is the plan schematic diagram of one reflective micromirror 311 of the second type of the reflective light valve 31.

As shown in FIG. 17 and FIG. 18, the second type of the reflective light valve 31 and the first type of the reflective light valve 31 have the similar components, but the difference between the second type of the reflective light valve 31 and the first type of the reflective light valve 31: the rotation axis Ax of each reflective micromirror 311 is not parallel to the short side W3 and the long side L3 of the effective image region V of the second type of the reflective light valve 31 separately. Similarly, each reflective micromirror 311 of the second type of the reflective light valve 31 is adapted to be operated in the first state with the first deflection angle, the second state without any deflection angle and the third state with the second deflection angle.

FIG. 19 is the schematic diagram of the different illumination regions on the second reference plane P2 formed by the illumination light beam S after being incident on the second type of the reflective light valve 31 with the reflective micromirrors 311 on the different states.

In conjunction with FIG. 19, when each reflective micromirror 311 is in the first state, the reflective micromirrors 311 reflect the illumination light beam S to form the first light beam serving as the image light beam S1, and the first light beam forms the first illumination region r1 on the second reference plane P2. When each reflective micromirror 311 is in the second state, the reflective micromirrors 311 reflect the illumination light beam S to form the second light beam, and the second light beam forms the second illumination region r2 on the second reference plane P2. When each reflective micromirror 311 is in the third state, the reflective micromirrors 311 reflect the illumination light beam S to form the third light beam, and the third light beam forms the third illumination region r3 and the diffraction patterns r0 on the second reference plane P2.

In the application architecture of the second type of the reflective light valve 31, the illumination light beam S is adapted to be operated in the state where the first projection optical axis F is not parallel to the long side L3 and the short side W3 separately.

Similar to the principle of the first type of the reflective light valve 31, the contours of the illumination regions which the first light beam, the second light beam and the third light beam reflected by the reflective light valve 31 form on the second reference plane P2 where the aperture AP of the projection lens 40 is located correspond to the shape of the first micro lens 131 of the first micro lens array 13, and as a result, the shape of the first illumination region r1, the shape of the second illumination region r2 and the shape of the third illumination region r3 correspond to the first shape of the first orthogonal projection P131 of the first micro lens 131 on the first reference plane P1.

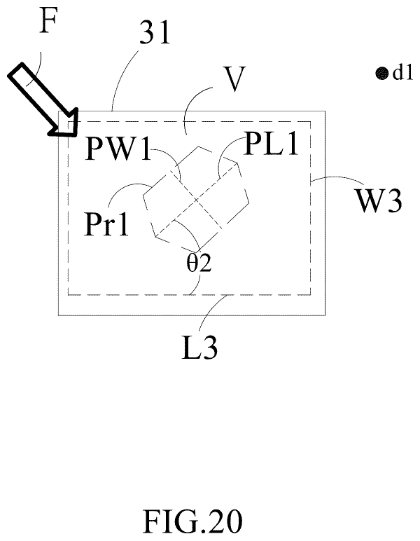

Thereafter, in the application architecture of the second type of the reflective light valve 31, the relationship between the first illumination region r1, the second type of the reflective light valve 31 and the illumination light beam S would be elaborated. FIG. 20 is the schematic diagram of the orthogonal projection Pr1 on the reflective light valve 31 of the first illumination region r1.

Please further refer to FIG. 3, FIG. 4 and FIG. 20. The orthogonal projection Pr1 on the reflective light valve 31 of the first illumination region r1 is provided with the projection long axis PL1 and the projection short axis PW1 which are perpendicular to each other. The projection long axis PL1 and the projection short axis PW1 respectively correspond to the first axis L1 and the second axis W1 of the first orthogonal projection P131 of the first micro lens 311 on the first reference plane P1. When the illumination light beam S is incident on the reflective light valve 31, the orthogonal projection Pr1 of the optical axis of the illumination light beam S on the reflective light valve 31 is the first projection optical axis F, and the first projection optical axis F is parallel to the projection short axis PW1. Thus, under the condition that the ratio of the projection long axis PL1 and the projection short axis PW1 is fixed, the parallelism of the first projection optical axis F and the projection short axis PW1 can ensure that the distance between the second illumination region r2 and the first illumination region r1 is the greatest, thereby preventing the second light beam generated when the reflective micromirror 311 is in the second state from entering the aperture AP.

Because the projection long axis PL1 and projection short axis PW1 respectively correspond to the first axis L1 and the second axis W1, the length of the projection long axis PL1 and the length of the projection short axis PW1 equally meet formula (2) similar to formula (1) and would not be repeated.

In the application architecture of the second type of the reflective light valve 31, because the first projection optical axis F is not parallel to the long side L3 and the short side W3 of the effective image region V separately, and the projection short axis PW1 should be parallel to the first projection optical axis F, the projection long axis PL1 is not parallel to the long side L3 and the short side W3 of the effective image region V separately. In some embodiments, the included angle θ 2 between the projection long axis PL1 of the orthogonal projection Pr1 and the long side L3 of the effective image region V is approximately equal to 45 degrees.

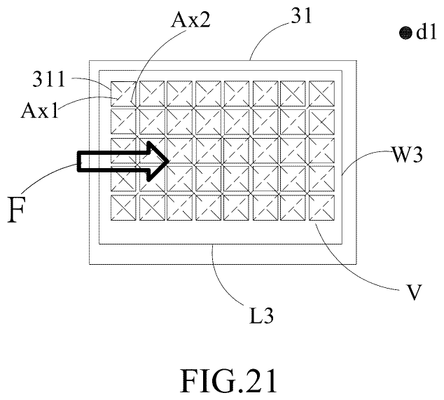

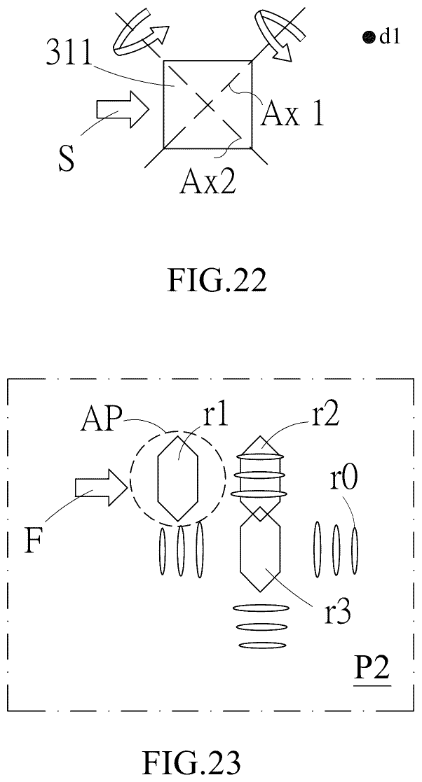

FIG. 21 is the plan schematic diagram of the third type of the reflective light valve 31 according to the present disclosure. FIG. 22 is the plan schematic diagram of one reflective micromirror 311 of the third type of the reflective light valve 31.

As shown in FIG. 21 and FIG. 22, the third type of the reflective light valve 31 and the first type of the reflective light valve 31 have the similar components, but the difference between the third type of the reflective light valve 31 and the first type of the reflective light valve 31: each reflective micromirror 311 has a rotation axis Ax and a pivot axis Ax2 which are disposed perpendicular to each other for example, and the rotation axis Ax and the pivot axis Ax2 are not parallel to the long side L3 and the short side W3 of the effective image region V of the reflective light valve 31 respectively. Each reflective micromirror 311 can separately rotate about the pivot axis Ax2 and/or the rotation axis Ax1. Similarly, each reflective micromirror 311 of the third type of the reflective light valve 31 is adapted to be operated in the first state with the first deflection angle, the second state without any deflection angle and the third state with the second deflection angle.

FIG. 23 is the schematic diagram of the different illumination regions on the second reference plane P2 formed by the illumination light beam S after being incident on the third type of the reflective light valve 31 with the reflective micromirrors 311 on the different states.

Please refer to FIG. 23. When each reflective micromirror 311 is in the first state, the reflective micromirrors 311 reflect the illumination light beam S to form the first light beam serving as the image light beam S1, and the first light beam forms the first illumination region r1 on the second reference plane P2. When each reflective micromirror 311 is in the second state, the reflective micromirrors 311 reflect the illumination light beam S to form the second light beam, and the second light beam forms the second illumination region r2 on the second reference plane P2. When each reflective micromirror 311 is in the third state, the reflective micromirrors 311 reflect the illumination light beam S to form the third light beam, and the third light beam forms the third illumination region r3 and the diffraction patterns r0 on the second reference plane P2.

In the application architecture of the third type of the reflective light valve 31, the illumination light beam S is adapted to be operated in the state where the first projection optical axis F is parallel to the long side L3, thereby generating the arrangement of the first illumination region r1, the first illumination region r1 and the third illumination region r3 as shown in FIG. 23.

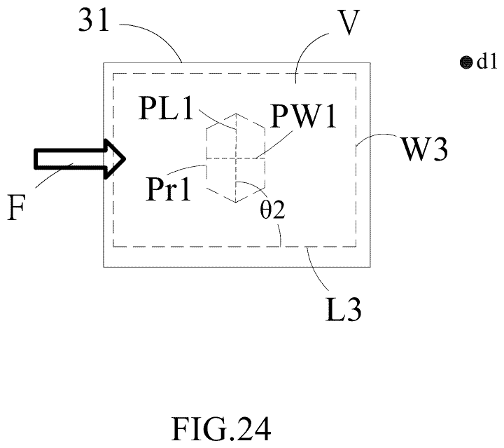

Similar to the principle of the first type of the reflective light valve 31 and the principle of the second type of the reflective light valve 31, the contours of the illumination regions which the first light beam, the second light beam and the third light beam reflected by the reflective light valve 31 form on the second reference plane P2 where the aperture AP of the projection lens 40 correspond to the shape of the first micro lens 131 of the first micro lens array 13. As a result, the shape of the first illumination region r1, the shape of the second illumination region r2 and the shape of the third illumination region r3 correspond to the first shape of the first orthogonal projection P131 of the first micro lens 131 on the first reference plane P1. For example, the shape of the first illumination region r1, the shape of the second illumination region r2 and the shape of the third illumination region r3 as shown in FIG. 24 correspond to the first shape of the first orthogonal projection P131 on the first reference plane P1 of the first micro lens 131 of the second type of the first micro lens array 13 as shown in FIG. 5 and FIG. 6.

Thereafter, the relationship between the first illumination region r1, the third type of the reflective light valve 31 and the illumination light beam S would be elaborated. FIG. 24 is the schematic diagram of the orthogonal projection Pr1 on the reflective light valve 31 of the first illumination region r1.

In conjunction with FIG. 5, FIG. 6 and FIG. 24, the orthogonal projection Pr1 which the first illumination region r1 forms on the reflective light valve 31 is provided with the projection long axis PL1 and the projection short axis PW1 which are perpendicular to each other. The projection long axis PL1 and the projection short axis PW1 respectively correspond to the first axis L1 and the second axis W1 of the first orthogonal projection P131 of the first micro lens 311 on the first reference plane P1. When the illumination light beam S is incident on the reflective light valve 31, the orthogonal projection Pr1 of the optical axis of the illumination light beam S (the major ray) on the reflective light valve 31 is the first projection optical axis F, and the first projection optical axis F is parallel to the projection short axis PW1. Thus, under the condition that the ratio of the projection long axis PL1 and the projection short axis PW1 is fixed, the parallelism of the first projection optical axis F and the projection short axis PW1 can ensure that the distance between the second illumination region r2 and the first illumination region r1 is the greatest, thereby preventing the second light beam generated when the reflective micromirror 311 is in the second state from entering the aperture AP.

Because the projection long axis PL1 and projection short axis PW1 respectively correspond to the first axis L1 and the second axis W1, the length of the projection long axis PL1 and the length of the projection short axis PW1 equally meet formula (2) similar to formula (1) and would not be repeated.

In the application architecture of the third type of the reflective light valve 31, because the first projection optical axis F is parallel to the long side L3 of the effective image region V, and the first projection optical axis F should be parallel to the projection short axis PW1, the projection short axis PW1 is parallel to the long side L3 of the effective image region V, and the projection long axis PL1 is perpendicular to the long side L3 of the effective image region V, i.e., the included angle θ 2 is about 90 degrees.

In view of the above descriptions, no matter which one of the first type of the reflective light valve 31 to the third type of the reflective light valve 31 is implemented, by setting the angle and the shape of the first micro lens 131, the overlapping area between the first illumination region r1 and the second illumination region r2, which is generated by the reflection of the reflective light valve 31, is reduced, the distance between the first illumination region r1 and the second illumination region r2 is greater, and/or even the first illumination region r1 and the second illumination region r2 do not overlap. Preferably, it would be also possible that the second illumination region r2 and the aperture AP do not overlap. Thus, the second light beam generated when the reflective micromirror 311 of the reflective light valve 31 is in the second state would not enter the aperture AP of the projection lens 40, so that only the first light beam when the reflective micromirror 311 of the reflective light valve 31 is in the first state enters the aperture AP as the image light beam S1 and forms a projection image, and the contrast ratio is improved under the condition that the brightness is not sacrificed. In addition, because the distances between the first illumination region r1, the second illumination region r2 and the third illumination region r3 formed by the corresponding reflective micromirrors 311 on the different states are greater, the diffraction pattern r0 generated by the third light beam is further away from the aperture AP so that the contrast ratio is further improved. Even better, the second illumination region r2 and the third illumination region r3 do not overlap the aperture on the second reference plane P2, and the better quality of the image is offered.

It should be noted that FIG. 13 to FIG. 24 of the present disclosure take the hexagon as an example to depict the first shape of the first orthogonal projection P131 of the first micro lens array 13, but the present disclosure is not limited thereto. As shown in FIG. 8 to FIG. 12, the first shape may also be the other shapes such as the rectangleor the ellipse, as long as the ratio of the length of the first axis L1 and the length of the second axis W1 and the shapes of the first axis L1 and the second axis W1 meet the requirement such that the distance between the second illumination region r2 and the first illumination region r1 generated by the reflective light valve 31 is the greatest and/or the second illumination region r2 and the first illumination region r1 generated by the reflective light valve 31 do not overlap.

In conjunction with FIG. 1, FIG. 3 and FIG. 13, in some embodiments, the reference line R is parallel to the projection long side of the orthogonal projection on the first reference plane P1 of the long side L3 of the effective image region V of the reflective light valve 31.

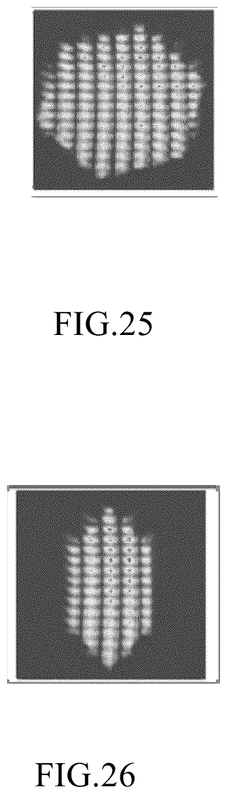

FIG. 25 is the simulation diagram of the first illumination region r1 formed according to the first micro lens array 13 shown in FIG. 3.

FIG. 26 is the simulation diagram of the first illumination region r1 formed according to the first micro lens array 13 shown in FIG. 5.

As seen from FIG. 25 and FIG. 26, the illumination region of the image light beam S1 on the second reference plane P2 corresponds exactly to or be similar to the first shape of the first orthogonal projection P131 of the first micro lens 131.

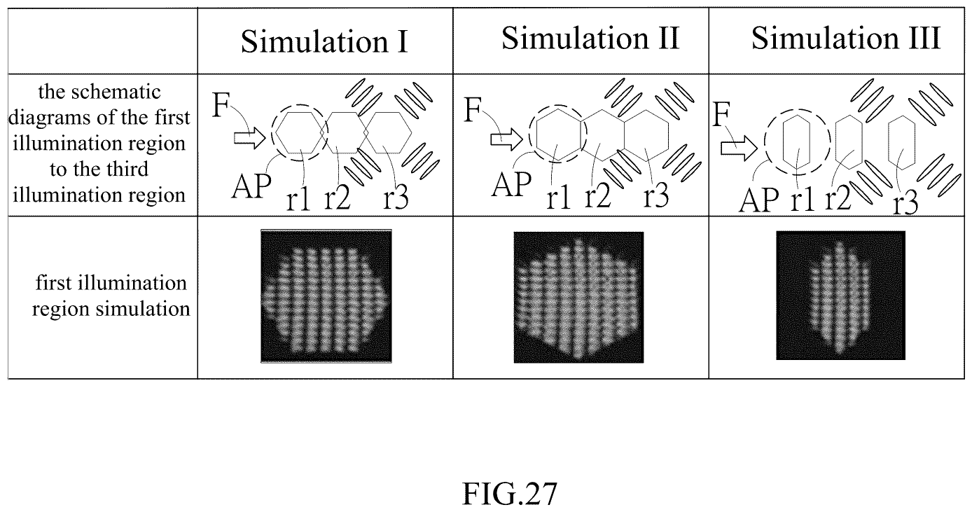

FIG. 27 is the comparison diagram of simulation results under the application architecture of the first type of the reflective light valve. In conjunction with FIG. 3 to FIG. 8, simulation I is simulated under the condition that the aspect ratio A of the first orthogonal projection P131 of the first micro lens 131 is 1 and the intersection angle θ is 0 degrees, i.e., the simulation in which the technical solution of the present is not adopted; simulation II is simulated under the condition that the aspect ratio A of the first orthogonal projection P131 of the first micro lens 131 is 1 and the intersection angle θ is 90 degrees; simulation III is simulated under the condition that the aspect ratio A of the first orthogonal projection P131 of the first micro lens 131 is 0.5 and the intersection angle θ is 90 degrees

As seen from the schematic diagrams of the first illumination region to the third illumination region of simulation I to simulation III, the second illumination region r2 and the first illumination region r1 of simulation II do not overlap; the second illumination region r2 of simulation III do not overlap the first illumination region r1 of simulation III and the aperture AP. Furthermore, according to the simulation results of simulation I to simulation III, if the brightness and the contrast ratio of the first illumination region generated by simulation I is a standard (100%), the brightness of the first illumination region generated by simulation II declines by 1.1%(−1.1%), and the contrast ratio of the first illumination region generated by simulation II increases by 33.3%(+33.3%); the brightness of the first illumination region generated by simulation III declines by 0.4%(−0.4%), and the contrast ratio of the first illumination region generated by simulation III increases by 161.1%(+161.1%). As seen from above, the present disclosure achieves the purpose of increasing the contrast ratio significantly and reducing the loss of the brightness by changing the shape and the angle of the first micro lens 131. In addition, the present disclosure may also solve the problem of the non-uniform red light beam in the projection image. Specifically, some reflective micromirrors 311 in the third state of the reflective light valve 31 in the current projector result in the phenomenon that the partially non-uniform red light beam is present in the projection image due to the diffraction patterns of the red light beam. By the configuration of the first micro lens array of the present disclosure, the diffraction patterns of the red light beam in the above state are further reduced to enter the aperture, thereby improving the problem of the partially non-uniform red light beam.

It should be noted that the terms “include”, “contain”, and any variation thereof in the present disclosure are intended to cover a non-exclusive inclusion. Therefore, a process, method, object, or device that comprises a series of elements not only include these elements, but also comprises other elements not specified expressly, or may include inherent elements of the process, method, object, or device. If no more limitations are made, an element limited by “include a/an . . . ” does not exclude another same element existing in the process, the method, the article, or the device which comprises the element.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projector comprising:
an illumination module configured to provide an illumination light beam and comprising a light source device and a first micro lens array, wherein the light source device generates a light beam, the first micro lens array comprises a plurality of first micro lenses which are arranged tightly, each of the first micro lenses forms a first orthogonal projection on a first reference plane, and the first orthogonal projection has a first shape; the first micro lens array is disposed on a transmission path of the light beam, and the light beam passes through the first micro lens array and leaves the illumination module as the illumination light beam;
a reflective light valve disposed on a transmission path of the illumination light beam, configured to convert the illumination light beam into an image light beam and comprising a plurality of reflective micromirrors which are arranged as an array, wherein the reflective micromirrors form an effective image region with a long side and a short side, and each of the reflective micromirrors is adapted to be selectively operated in one of a first state with a first deflection angle and a second state without deflection angle;
wherein the illumination light beam is incident on the reflective micromirrors when each of the reflective micromirrors is in the first state, and the reflective micromirrors reflect the illumination light beam to form a first light beam as the image light beam;
wherein the illumination light beam is incident on the reflective micromirrors when each of the reflective micromirrors is in the second state, and the reflective micromirrors reflect the illumination light beam to form a second light beam;
a projection lens disposed on a transmission path of the image light beam, configured to project the image light beam out of the projector to form an image; the projection lens comprises an aperture disposed on a second reference plane perpendicular to an optical axis of the projection lens;
wherein the first light beam forms a first illumination region on the second reference plane, the second light beam forms a second illumination region on the second reference plane, a shape of the first illumination region and a shape of the second illumination region correspond to the first shape, and the first illumination region overlaps the aperture; an orthogonal projection of the first illumination region on the reflective light valve is provided with a projection short axis and a projection long axis perpendicular to the projection short axis, and an included angle between the projection long axis and the long side of the effective image region is greater than 0 degrees and less than or equal to 90 degrees.

2. The projector according to claim 1, wherein the second illumination region and the aperture do not overlap.

3. The projector according to claim 1, wherein each of the reflective micromirrors is adapted to be operated in a third state with a second deflection angle, the illumination light beam is incident on the reflective micromirrors when each of the reflective micromirrors is in the third state, and the reflective micromirrors reflect the illumination light beam to form a third light beam; the third light beam forms a third illumination region on the second reference plane, and the first illumination region and the third illumination region do not overlap.

4. The projector according to claim 1, wherein an orthogonal projection of an optical axis of the illumination light beam on the reflective light valve is a first projection optical axis parallel to the projection short axis when the illumination light beam is incident on the reflective light valve.

5. The projector according to claim 4, and each of the reflective micromirrors has a rotation axis which is not parallel to the long side and the short side of the effective image region separately.

6. The projector according to claim 4, and each of the reflective micromirrors has a rotation axis which is parallel to the long side and the short side of the effective image region.

7. The projector according to claim 4, each of the reflective micromirrors has a rotation axis and a pivot axis which are perpendicular to each other, and the rotation axis and the pivot axis are not parallel to the long side and the short side of the effective image region separately.

8. The projector according to one of claim 4, wherein a length of the projection long axis and a length of the projection short axis meet a formula as follows:
$$\frac{D 2}{D 1} = \frac{\sqrt{3}}{2} * A$$
wherein D1 is the length of the projection long axis, D2 is the length of the projection short axis, and 0.3≤A≤1.

9. The projector according to claim 4, wherein the first micro lens array is disposed along the first reference plane, and the light beam is incident on the first micro lens array along a first incident direction perpendicular to the first reference plane; the first shape has a first axis and a second axis, a length of the first axis is greater than a length of the second axis, and the projection long axis and the projection short axis of the orthogonal projection of the first illumination region on the reflective light valve respectively correspond to the first axis and the second axis.

10. The projector according to claim 9, wherein the first axis and the second axis are symmetric axes of the first shape.

11. The projector according to claim 10, wherein the first shape is a quadrangle, a hexagon or an octagon.

12. The projector according to claim 10, wherein the first shape is a polygon; a connecting line between two opposite corners of the polygon is the first axis, a connecting line between two midpoints of two opposite sides of the polygon is the second axis, and the first axis is perpendicular to the second axis.

13. The projector according to claim 10, wherein the first shape is an ellipse, the first axis is a major axis of the ellipse, and the second axis is a minor axis of the ellipse.

14. The projector according to claim 9, wherein a length of the first axis and a length of the second axis meet a formula as follows:
$$\frac{D 4}{D 3} = \frac{\sqrt{3}}{2} * A$$
wherein D3 is the length of the first axis, D4 is the length of the second axis, and 0.3≤A≤1.

15. The projector according to claim 9, wherein there is an intersection angle between the first axis of the first shape and a reference line, the intersection angle is greater than or equal to 0 degrees and less than or equal to 90 degrees, and the reference line is located on the first reference plane and is parallel to a projection long side of an orthogonal projection of the effective image region of the reflective light valve on the first reference plane.

16. The projector according to claim 1, wherein the illumination module comprises a second micro lens array disposed on the transmission path of the light beam, and the light beam sequentially passes through the first micro lens array and the second micro lens array.

17. The projector according to claim 16, wherein a direction in which the light beam is incident on the first micro lens array and a direction in which the light beam is incident on the second micro lens array are parallel and opposite.

18. The projector according to claim 16, further comprising:
a transparent component disposed along the first reference plane and provided with a first region and a second region, wherein the first micro lens array is disposed on the first region, and the second micro lens array is disposed on the second region.
